(19) United States
(12) Patent Application Publication
(10) Pub. No.: US 2003/0000758 A1
(43) Pub. Date: Jan. 2, 2003

(54) Fuel cell installation and method for operating the fuel cell installation

(76) Inventors: Rolf Bruck, Bergisch Gladbach (DE); Joachim Grosse, Erlangen (DE); Jorg-Roman Konieczny, Siegburg (DE); Meike Reizig, Bonn (DE)

Correspondence Address: LERNER AND GREENBERG, P.A., Post Office Box 2480, Hollywood, FL, 33022-2480, US

(21) Appl. No.: 10/178,255

(22) Filed: Jun. 24, 2002

Related U.S. Application Data
(63) Continuation of application No. PCT/DE00/04594, filed on Dec. 22, 2000.

(30) Foreign Application Priority Data
Dec. 23, 1999 (DE) 199 62 680.4

(51) Int. Cl. B60K 1/00; B60L 3/04

(52) U.S. Cl. 180/279; 180/65.1

(57) ABSTRACT

The fuel cell installation, which is particularly suitable in mobile applications, includes an emergency shut-down device. The device for shutting down brings about a closure of the hydrogen supply and in addition, when necessary, further measures including disconnecting and/or blowing the devices for conducting current and/or voltage.

### CROSS-REFERENCE TO RELATED APPLICATION

This application is a continuation of copending International Application No. PCT/DE00/04594, filed Dec. 22, 2000, which designated the United States and was not published in English.

### BACKGROUND OF THE INVENTION

### FIELD OF THE INVENTION

The invention lies in the fuel cell technology field and relates, more specifically, to a fuel cell installation with a device for rapid shutdown. In addition, the invention relates to a method for operating a fuel cell installation having such a shutdown device in a motor vehicle.

German patent DE 196 30 842 C1 discloses a device for rapidly shutting down fuel cells, wherein a fuel cell are provided with a plurality of individual cells connected to one another via gas lines, and means for emergency shutting down the fuel cell when a fault occurs. In order to avoid a large amount of damage in the event of a fault, means are provided for interrupting the gas line connections, which means disconnect the individual fuel cells from one another in terms of gas equipment when an emergency shut down occurs. Furthermore, U.S. Pat. No. 5,193,635 discloses a vehicle with a fuel cell drive wherein the fuel cell stack is used as an energy carrier of the drive unit of the vehicle.

A disadvantage with the latter system in the motor vehicle is that in the event of the fuel cell installation approaching a critical point—whether in terms of the parameters “temperature”, “pressure”, etc. or other significant variables—there are no protection measures provided to allow for a risk of explosion which is presented bKy the fuel cell, in particular by the hydrogen supply of the hydrogen tank of the complete fuel cell installation.

Particular measures for protecting fuel cell installations which are used specifically in the mobile field are generally not provided. In this context, in view of the fact that in the event of a short circuit caused, for example, by a vehicle accident, the fuel cell installation continues to generate current which is not consumed, a protection measure which eliminates the risk of an electric shock is all but indispensable.

### SUMMARY OF THE INVENTION

It is accordingly an object of the invention to provide a fuel cell installation and an operating method, which overcomes the above-mentioned disadvantages of the heretofore-known devices and methods of this general type and provide suitable protection measures for a fuel cell installation and also specifies a suitable operating method for operating the unit.

With the foregoing and other objects in view there is provided, in accordance with the invention, a fuel cell installation and a device for rapid shutdown, comprising:

a measuring and control unit having inputs for receiving sensor signals from the sensors and outputs for control lines for deactivating one or more lines selected from the group consisting of the fuel lines, the process gas lines, and electrical lines for effecting an emergency shut-down.

In other words, the objects of the invention are achieved with a fuel cell installation of the type mentioned in the introductory text provided with a device for emergency shutdown. In addition, the subject matter of the invention is a method for operating a fuel cell installation in a vehicle with which it is possible to ensure that as soon as there is the risk that a critical operating state could be reached in the fuel cell installation and/or in the motor vehicle, the unit and/or the reformer are automatically shut down and disconnected from the fuel supply and/or the devices for conducting current and/or voltage are removed.

The device for emergency shutting down in the stack and/or in the end plates and/or in the housing of the stack preferably comprises a control and measuring device so that when specific operating states occur (temperature, pressure, voltage), the fuel supply and/or the electrical connections are automatically disconnected or isolated. This then also leads directly to switching off of the unit.

In the invention, a plurality of sensors which are mounted at critical points in the unit provide the measuring device with the information relating to the operating state of the unit and/or a short circuit. If one of the measurements indicates the unit is approaching a critical operating state, the connected control device automatically shuts off the fuel supply. “Fuel” is understood here to be not only the process gases but also the fuel which flows into the reformer.

If this measure does not lead to the system calming down, the control device blows the connection, and if appropriate also the blowing of the “devices for conducting current and/or voltage” and/or causes all the valves to be closed.

Electrical lines as understood herein are current-conducting lines and voltage-conducting lines, and devices for conducting current and/or voltage is understood to mean the current-conducting cables and voltage loads, electrical lines and/or distributors by means of which the up to 500 V of the unit are conducted.

In accordance with an added feature of the invention, the fuel lines and process gas lines are controlled with inline valves, and the measuring and control unit shuts down the valves in an emergency shut-down.

The invention is particularly suitable in the field of electrotraction and, specifically, in the motor vehicle field. The sensors are preferably distributed in groups and they include temperature sensors, pressure sensors, voltage sensors, and the like.

With the above and other objects in view there is also provided, in accordance with the invention, a motor vehicle that is driven by a fuel cell installation with a device for rapid shutdown, comprising:

a fuel cell unit having a fuel line, a process gas line, and an electrical line;

one or more crash sensors disposed in the motor vehicle;

a measuring and control unit having an input connected to receive an operative signal from the crash sensor and outputs for control lines for deactivating one or more lines selected from the group consisting of the fuel line, the process gas line, and the electrical line for effecting an emergency shut-down.

In accordance with a particular feature of the invention, the crash sensor is disposed in a fender of the motor vehicle. In a preferred system, the crash sensor is operatively connected to at least one airbag of the motor vehicle and/or to a seat belt in the motor vehicle (e.g., the driver's seat seatbelt).

In accordance with again an added feature of the invention, the sensor is one of a group of crash sensors distributed about the motor vehicle, and wherein additional sensors such as temperature sensors, pressure sensors, and/or voltage sensors are disposed in the motor vehicle.

In accordance with again an additional feature of the invention, the measuring and control unit includes a microcontroller for processing the measured values and for comparing the measured values with stored operating curves.

With the above and other objects in view there is also provided, in accordance with the invention, a method for operating a fuel cell installation in a vehicle, which comprises:

monitoring operating states of one of the fuel cell installation and of the motor vehicle;

if a critical operating state is reached, automatically shutting down the fuel cell installation by at least one of disconnecting the fuel cell installation from a fuel supply and deactivating all devices carrying electrical energy.

In accordance with a concomitant feature of the invention, if the critical operating state is reached, all secondary lt assemblies, such as a reformer of the fuel cell installation are automatically shut down.

Other features which are considered as characteristic for the invention are set forth in the appended claims.

Although the invention is illustrated and described herein as embodied in a fuel cell installation and method for operating the unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram of a motor vehicle with a fuel cell installation for supplying power to the electric motor; and

FIG. 2 is a schematic block diagram of a device for the emergency shutting down of the fuel cell installation or of the motor driven by it.

### DESCRIPTION OF THE PREFERRED EMBODIMENTS

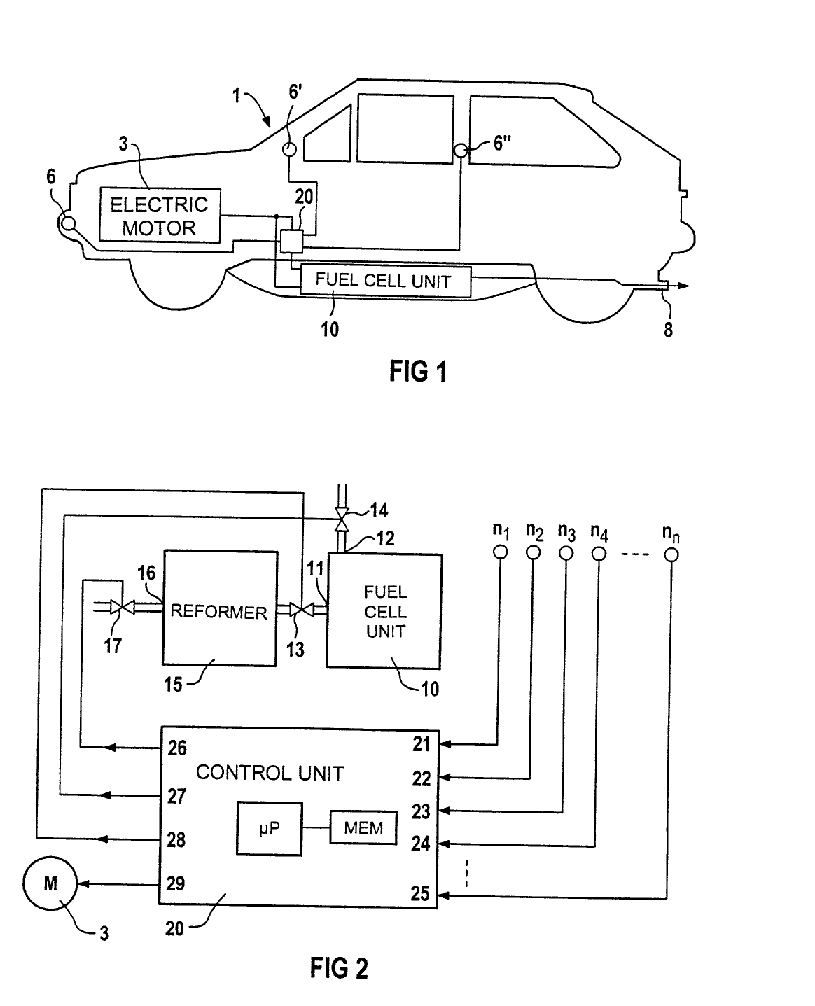

Referring now to the figures of the drawing in detail and first, particularly, to FIG. 1 thereof, there is shown a motor vehicle 1 which has, for example, an electric motor 3 as drive and fuel cell installation 10 for supplying the drive. The fuel cell installation can advantageously be what is referred to as a PEM (Proton Exchange Membrane) fuel cell, in particular also an HT fuel cell, which operates in the range from 80 to 300° C. at temperatures which are increased in comparison with the normal temperature. The PEM fuel cell is operated with hydrogen or hydrogen-rich gas that is acquired by reformation from alcohols, for example methanol, or else also acquired from gasoline, and oxygen, in particular atmospheric oxygen from the surroundings as an oxidant.

For the sake of completeness, an exhaust system 8 is shown wherein product water can be output when the unit is operated with pure hydrogen, or else other exhaust gases which are generated can be output when the unit is operated with hydrogen-rich gas. Furthermore, sensors 6, 6′, 6″ are present whose signals are transmitted to a control device 20, on which further details are given below.

The electrical connection from the fuel cell installation 10 to the electric motor is to be interrupted in the case of faults. The fuel cell installation 10 according to FIG. 1 has a device for emergency shutdown 20 so that, in the case of a risk due to short circuit and/or when a critical operating state is reached, all the devices for conducting current and/or voltage, such as the electrical lines, distributors, etc. are automatically disconnected from the vehicle and/or from the stack and/or the fuel supply is closed off. The device for emergency shutting down firstly provides at least for the fuel supply to be closed and in addition, when required, further measures such as disconnection and/or blowing of the devices for conducting current and/or voltage. The essential factor here is that both critical operating states of the fuel cells and critical states of the motor vehicle, for example due to an accident or the like, are taken into account and lead to the shutting off of the entire fuel cell installation.

FIG. 2 illustrates the device for emergency shutting off in detail: a measuring and control device 20, identified in the figure as a control unit, receives via inputs 21 to 25 the signals of a series of sensors. There are, on the one hand, sensors at least for the parameters of “temperature T”, “pressure P” and “voltage U”, and, on the other hand, also what are referred to as crash sensors. There is advantageously a multiplicity of groups of such sensors which are mounted at the specific locations in the unit. In particular, in the vehicle 1 shown in FIG. 1, the crash sensors may be arranged in the fenders or be coupled to the airbag or to the belt pretensioner of the seat belts. Such sensors are designated by 6, 6′ and 6″ in FIG. 1.

According to FIG. 2, five of a total of n sensors are illustrated by way of example. Furthermore, the fuel cell installation 10 is completed with a reformer 15. This means that the reformer 15 processes a fuel to form hydrogen-rich gas which is a process gas of the fuel cell installation 10. The other process gas, namely the oxidant, is acquired, for example, from the ambient air.

FIG. 2 further illustrates exemplary valves 13, 14 for the process gases and a valve 16 for the fuel. As soon as one of the sensors responds, the control device is activated and, if appropriate, control signals or actuating signals are activated.

The measuring and control device 20 is illustrated with a microcontroller or microprocessor μP and a memory MEM in which characteristic curves or operating curves are stored. In the device 20, limiting values are acquired in accordance with the recorded signals that are advantageously compared with the stored characteristic curves in the computer-supported control unit. When the limiting values are reached the device for emergency shutdown is activated. This means that predefined values can be set in such a way that as soon as there is the risk that a critical operating state could be reached, the unit and/or the reformer are automatically shut down. Furthermore, the fuel supply to the reformer is also disconnected. Finally, all the devices for conducting current and/or voltage can also be deactivated.

The fuel cell installation has been described above in the application in electrotraction, specifically in particular for use in motor vehicles. Corresponding principles also apply in other applications of fuel cell installations.

We claim:

1. In a fuel cell installation having sensors and a plurality of lines including fuel lines, process gas lines, and electrical lines, a device for rapid shutdown, comprising:
a measuring and control unit having inputs for receiving sensor signals from the sensors and outputs for control lines for deactivating one or more lines selected from the group consisting of the fuel lines, the process gas lines, and electrical lines for effecting an emergency shut-down.

2. The device according to claim 1, wherein the fuel lines and process gas lines include inline valves, and said measuring and control unit shuts down said valves in an emergency shut-down.

3. The device according to claim 1, wherein the electrical lines are selected from the group consisting of current-conducting lines and voltage-conducting lines.

4. The device according to claim 1 integrated in a fuel cell installation for electrotraction.

5. The device according to claim 4 integrated in a fuel cell installation for driving a motor vehicle.

6. The device according to claim 1, which comprises a plurality of sensors selected from the group of sensors consisting of temperature sensors, pressure sensors, and voltage sensors.

7. In a motor vehicle, a fuel cell installation with a device for rapid shutdown, comprising:
a fuel cell unit having a fuel line, a process gas line, and an electrical line;
at least one crash sensor disposed in the motor vehicle;
a measuring and control unit having an input connected to receive an operative signal from said crash sensor and outputs for control lines for deactivating one or more lines selected from the group consisting of the fuel line, the process gas line, and the electrical line for effecting an emergency shut-down.

8. The fuel cell installation according to claim 7, wherein said crash sensor is one of a plurality of crash sensors distributed about the motor vehicle.

9. The fuel cell installation according to claim 7, wherein said crash sensor is disposed in a fender of the motor vehicle.

10. The fuel cell installation according to claim 7, wherein said crash sensor is operatively connected to at least one airbag of the motor vehicle.

11. The fuel cell installation according to claim 7, wherein said crash sensor is operatively connected to a seat belt in the motor vehicle.

12. The fuel cell installation according to claim 11, wherein the seat belt is a driver's seat seatbelt.

13. The fuel cell installation according to claim 7, wherein said sensor is one of a group of crash sensors distributed about the motor vehicle, and wherein additional sensors selected from the group consisting of temperature sensors, pressure sensors, and voltage sensors are disposed in the motor vehicle.

14. The fuel cell installation according to claim 7, wherein said measuring and control unit includes a microcontroller for processing the measured values and for comparing the measured values with stored operating curves.

15. The fuel cell installation according to claim 1, wherein said measuring and control unit includes a microcontroller for processing the measured values and for comparing the measured values with stored operating curves.

16. A method for operating a fuel cell installation in a vehicle, which comprises:
monitoring operating states of one of the fuel cell installation and of the motor vehicle;
if a critical operating state is reached, automatically shutting down the fuel cell installation by at least one of disconnecting the fuel cell installation from a fuel supply and deactivating all devices carrying electrical energy.

17. The method according to claim 16, which comprises, if the critical operating state is reached, automatically shutting down all secondary assemblies of the fuel cell installation.

18. The method according to claim 16, which comprises, if the critical operating state is reached, automatically shutting down a reformer of the fuel cell installation.
